(19) United States
(12) Patent Application Publication
(10) Pub. No.: US 2013/0311301 A1
(43) Pub. Date: Nov. 21, 2013

(54) CONTENT EASEMENT AND MANAGEMENT SYSTEM FOR INTERNET ACCESS PROVIDERS AND PREMISE OPERATORS

(71) Applicant: AD-VANTAGE NETWORKS, INC., Glendale, CA (US)

(72) Inventors: David Grant, Mission Viejo, CA (US); Sanjeev Kuwadekar, Northridge, CA (US)

(21) Appl. No.: 13/896,057

(22) Filed: May 16, 2013

Related U.S. Application Data
(60) Provisional application No. 61/648,450, filed on May 17, 2012.
(60) Provisional application No. 61/793,832, filed on Mar. 15, 2013.

(51) Int. Cl. G06Q 30/02

(52) U.S. Cl. CPC G06Q 30/0273
USPC 705/14.69

(57) ABSTRACT

Certain embodiments of a Content Easement and Management System (CEMS) described herein may enable bandwidth/Internet access providers and premise operators to empirically track and collect entrance revenues for advertising and content provided over their networks and infrastructure. Advertising content may be identified by the system and, optionally, blocked and/or replaced prior to being transmitted to a user terminal. Advertising publishers may register with the system and agree to pay a fee in exchange for permission to have their advertising content provided to the user terminal.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

### BACKGROUND OF THE INVENTION

1. Field of the Invention

Embodiments disclosed herein relate to systems and methods for monitoring and controlling Internet access, such as by premise operators.

2. Description of the Related Art

The Internet has become an essential tool for large numbers of people. The Internet is used to perform searches, run applications, review content, communicate with others, house emails and files, etc.

With respect to the Internet it has proved to be difficult for users and access providers to manage programming and content. In particular, because the content is now embedded in web pages it makes it difficult for users and access providers to manage the content they see or execute on their devices. For example, the Internet generally does not adequately enable the restriction of certain product placement such as tobacco advertisements in children's programming or the monitoring of produced or real-time streaming content. Further, from the perspective of consumers, the Internet suffers from other deficiencies. Publishers can add tags into their pages that display ads to the highest bidder or install scripts that access potentially private information. Embedded content is also the vehicle typically used to deliver viruses to users such as the Trojan Virus and RootKit virus which can be used to damage a user's finances, breach the user's privacy, and damage the user's connected device.

### SUMMARY OF THE INVENTION

The present disclosure is related to methods and systems for monitoring and controlling Internet access, for example by premise operators or Internet access providers.

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one embodiment, a method of controlling transmission of digital content to a user terminal comprises: receiving, at a network node, data for a webpage from a remote system or systems, wherein the webpage is to be displayed on the user terminal; causing, at least in part, an automatic identification of a first advertisement in the webpage data; identifying, from data associated with the first advertisement, a publisher of the first advertisement; automatically determining whether the publisher of the first advertisement is included in a registration database, wherein the registration database comprises an identification of publishers that have agreed to pay fees in exchange for passage of advertisements over at least a first network; at least partly in response to determining that the publisher of the first advertisement is included in a registration database, generating an indication that the first advertisement is to be displayed on the user terminal; at least partly in response to determining that the publisher of the first advertisement is not included in a registration database, generating an indication that the first advertisement is not to be displayed on the user terminal; outputting the webpage to a web browser associated with the user terminal, wherein: the first advertisement is displayed on the webpage at least partly in response to the indication that the first advertisement is to be displayed on the user terminal; and the first advertisement is replaced, obscured, or omitted at least partly in response to the indication that the first advertisement is not to be displayed on the user terminal. In some embodiments, the network node may block getting of the ad call. In some embodiments, rather than identifying an advertisement, the node may identify a data aggregator, for example based on dropped cookies that are placed for collecting targeting information, uniform resource identifier (URI), or uniform resource locator (URL).

Certain embodiments comprise a method of controlling transmission of digital content to a user terminal, the method comprising: receiving, at a network node, data for a first document from a remote system, wherein the first document is to be displayed on the user terminal of a user; causing, at least in part, an automatic identification of a first advertisement in the first document data; determining whether the first advertisement is permissible based at least in part on one or more characteristics comprising: (a) identity of a publisher of the first advertisement; (b) content rating of the first advertisement; (c) revenue offered for the first advertisement; and (d) account status of the publisher; causing the first document to be output to a user terminal, wherein: the first advertisement is displayed in the first document if the advertisement is determined to be permissible; or the first advertisement is replaced, obscured, or omitted if the first advertisement is determined to be not permissible.

An example embodiment provides a system comprising: a processor; tangible, non-transitory media configured to store a program that when executed by the process is configured to perform operations, comprising: receiving, at a network node, data for a first document from a remote system, wherein the first document is to be displayed on the user terminal of a user; causing, at least in part, an automatic identification of a first advertisement in the first document data; determining whether the first advertisement is permissible based at least in part on one or more characteristics comprising: (a) identity of a publisher of the first advertisement; (b) content rating of the first advertisement; (c) revenue offered for the first advertisement; and (d) account status of the publisher; causing the first document to be output to a user terminal, wherein: the first advertisement is displayed in the first document if the advertisement is determined to be permissible; or the first advertisement is replaced, obscured, or omitted if the first advertisement is determined to be not permissible.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 illustrates an example architecture for a content easement management system.

FIG. 2 illustrates an example process for allowing or restricting access of selective content based on the access provider's and/or the user's pre-determined settings.

FIG. 3 illustrates an example user interface.

FIG. 4 illustrates an example process for verifying a publisher's Internet credentials and applying system rules.

FIG. 5 illustrates another example user interface.

FIG. 6 illustrates another example process for verifying a publisher's Internet credentials and applying system rules.

FIG. 7 illustrates another example user interface.

FIG. 8 illustrates an example process for verifying a publisher's Internet credentials and applying system rules.

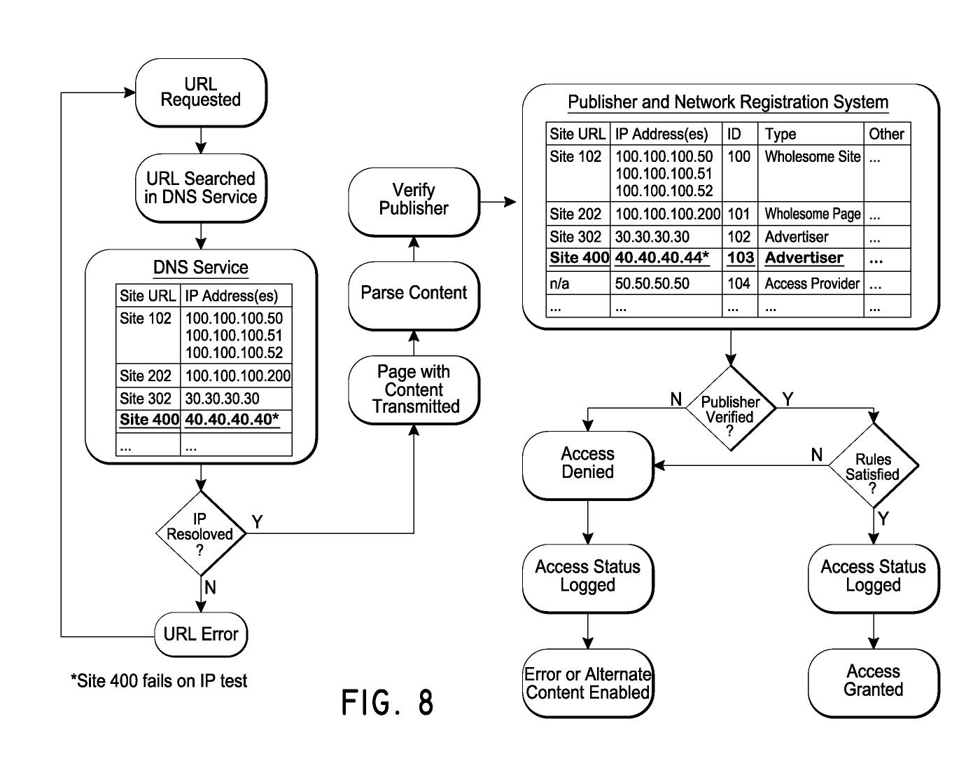

### DETAILED DESCRIPTION OF PREFERRED EMBODIMENTS

Certain embodiments of a content easement and management system (CEMS) described herein may enable bandwidth/Internet access providers and/or premise operators to enable the monitoring and modification of content provided over their network and/or infrastructure.

Certain embodiments of a CEMS described herein may enable bandwidth/Internet access providers and/or premise operators to empirically track and collect entrance revenues (e.g., on a standardized basis) for advertising and/or content provided over their networks and/or infrastructure. Optionally, these revenues may be employed to lower or eliminate consumer access costs by reducing or offsetting the access provider's infrastructure costs to enable Internet access. In addition or instead, such revenues may be used to improve consumers' access experience by enhancing access to more quality content and restricting distracting or irrelevant content such as popups, or distracting advertisements that are typically unwanted by consumers.

Today, access providers have few tools to protect their customers from inappropriate and potentially harmful content passing through their networks. Most transfer or avoid liability by requiring users to accept their Terms and Conditions before access is granted. Consumers and access providers often employ virus protection to look for suspect content that is previously known, but this is approach is not foolproof. Further, virus protection disadvantageously adds expense and reduces overall system and rendering performance.

In addition to potentially unsafe content, advertisers are paying high prices to reach consumers. The relatively few companies that aggregate and control advertising content are growing increasingly powerful. By contrast, providers that enable Internet access, often at great expense, do not share in the advertising revenue and are often forced to increase their access fee to consumers to enable and sustain Internet access. In addition, these powerful aggregators also install silent programs which collect large amounts of unchecked, unmonitored information about these consumers.

For example, consider that in less than one decade a small search engine company with limited or minimal content home page (Google) grew to be one of the most powerful companies with most of the acquisitions and revenues coming from controlling the placement of Internet advertisements. Certain companies are being investigated or fined by federal authorities for hacking, security breaches, privacy issues, unfair trade issues, effective paid censorship and more. Meanwhile, premise operators and access providers who pay for networks that deliver the ads, as well as consumers, whose resources are used to render the content, do not share in these revenues, and the revenues are retained by relatively few aggregators.

Consumers have come to accept that low cost or no cost access to programming or content is subsidized by paid advertisement but few have realized how this has affected the industry. As noted above, Internet access providers and premise operators are paying higher bandwidth costs and purchasing more access equipment to enable convenient access to content for consumers. Meanwhile, access providers and premise operators receive little or no revenues from the advertisers or the few companies controlling the delivery of these advertisements. In order to hold down costs or raise revenues, access providers and premise operators have resorted to limiting bandwidth or site access to consumers or charging more for enhanced convenience. For example, same offer tier access for a quality experience, or block sites with notoriously heavy streaming content. Aside from simply limiting bandwidth or blocking specific Internet destinations, access providers and premise operators lack an adequate ability to control or monetize content and advertising being displayed in their premise and delivered over their equipment. Certain users that consume large amounts of content, can effectively tune to any channel/URL, consume a disproportionate amount of shared bandwidth (clog), watch any desired programming, or improperly use this access without the knowledge or permission of the access providers, which typically causes the experience of others to degrade.

Many access providers transfer liability for access and many have turned to companies who can limit bandwidth or create tiered pricing to make these services available to consumers without losing money. Nonetheless, the model for Internet access providers and premise operators is out of balance.

Certain embodiments of the CEMS address some or all of the foregoing deficiencies in conventional approaches, by re-establishing balance and creating a level playing field for advertisers, consumers and Internet access providers that is measureable and auditable.

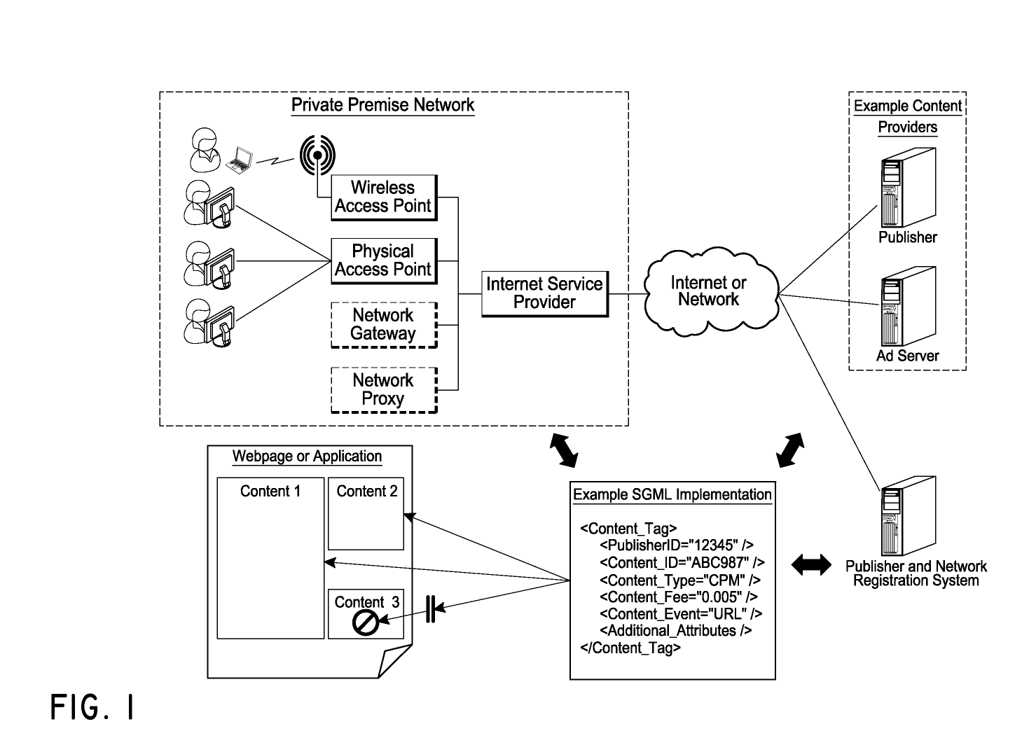

Embodiments of the CEMS can be implemented as software or firmware that may run on one or a plurality of computer system (including one or more processing devices) connected to a network and/or via the use of dedicated hardware. FIG. 1 illustrates an example architecture that may enable the protection of both end users and the network access providers that enable end user access. Other components and configurations may be used as well.

Consider in FIG. 1 that a user browses a webpage or app, and this webpage contains a multitude of content from different sources that is often dynamically created and determined only after reaching the user's connected device. For example, the connected device may be a terminal including a display and user input device. By way of example and not limitation, a terminal may be in the form a general purpose computer, a laptop computer, a tablet computer, a phone, a networked television, a gaming device, etc. In this example, the content publisher may surround some or all the content it publishes with HTML tags that identify the content source, the type of content that is being transmitted, the content rating, and other attributes that can be used to evaluate the safety and value of this content to the access provider and end user. Thus, for example, the tags may be monitored, and based at least in part on an examination of the tags or content, a determination may be made as to which content is to be displayed and which content is to be blocked or substituted with other content.

For illustrative purposes, FIG. 1 demonstrates that Content 1 and Content 2 are permitted by the CEMS; however, Content 3 fails to meet the requirements (e.g., specified by an access provider, premise operator, and/or user) and is blocked or substituted by the CEMS without affecting other content or page layout. In this example, Content 1 may be a news article of known origin as determined by inspection of Content 1 and/or associated metadata, such as associated tags (e.g., HTML tags) or page content. The tags or page content may identify the publisher as CNN or Wall Street Journal, for example. The content type may be labeled, via a tag or otherwise, as news, the fee (e.g., charged by the access provider or premise operator or a CPM (Cost per mille/thousand), CPC (Cost per click), or other fee (e.g., revenue) that the publisher or advertiser is willing to pay) may be specified via a tag or otherwise as $0.00, and the event tag (e.g., on mouse click, on advertisement loading, on page load, etc.) may have a null value or a token that might be time- or volume-based. In various embodiments, one or more of the tags and/or tag values may be omitted. For example, as described in more detail below, in some embodiments the fee, content type, height, and/or other attributes and associated tags may be omitted. In some embodiments, the decision of whether to permit an advertisement to be displayed may be based on an overriding contract, for example 20% of all advertisements may be served so long as the ad server company is current and registered. Payment may be reconciled at a later time based on the data.

In one embodiment, the fee charged/collected by the network provider may be determined by or specified in a registry associated with the CEMS based on previously agreed to terms, such as 20% of the CPM. Optionally, if the fee is not acceptable or another advertiser is willing to pay a higher fee, the access provider may choose, via the CEMS, to select the ad from the advertiser offering the higher fee. Content 2 may be an advertisement from a well-known ad serving provider, such as DoubleClick or ValueClick. The content type may be advertisement, the fee (as described above) may be $0.001 and the event may include additional actions if the user clicks on the advertisement. In this example, Content 3 may also be an advertisement but did not include the needed tags for identification purposes and/or failed to meet permission criteria, as indicated by a rating toll, such as a content rating for a given site. The CEMS may examine Content 3 and/or associated tags and determine that if failed a source identification determination and/or permission criteria. In some embodiments, the CEMS may record the display of the advertisement, and document the ad server URI or other identifying information. The advertiser may be billed at a later date, or if the advertiser does not have a valid current account (e.g., due to nonpayment or failure to enter into payment contract), the advertisement may be blocked.

In some embodiments, ad toll technology may be employed by the system. In an example embodiment, one or more toll booth locations or sites register with the registry and a given toll booth location records the passage of an ad based in whole or in part on delivery to a user.

Optionally, an advertisement has to be delivered in order for the network provider and/or publisher to be provided payment with respect to the advertisement. In an optional embodiment, if an advertisement traverses networks of multiple network operators, then revenues or payments with respect to the advertisement may be split among the multiple network operators and, in certain circumstances, the user to whom the advertisement is delivered. For example, if an ad traverses the networks of three network operators in order to reach the end user terminal, and each of the network operators (and optionally the user) is registered with the system, then the revenue may be split based at least in part on one or more network parameters (how many network segments (e.g., network operator A might traverse the advertisement from point A to B via a national network link, network operator B might traverse the advertisement from point B to point C via a local ISP link, and network operator C might traverse the advertisement from Point C to the user terminal via their WiFi network), how far or number of hops (e.g., the number of routers or routes traversed from the sender to the receiver, in which optionally a given router/route may have an associate detailed cost)) and/or what percentage or revenue cut is indicated by the ad tag itself, registry rules, and/or otherwise. The network parameters may be equally or unequally weighted in determining how the revenues/fees are to be split.

Access requirements may optionally be configured and managed in an access profile record via a web application or client application accessed by a customer or account manager. This profile may include rules or access thresholds based on physical location, bandwidth characteristics, virtual location, cost metrics, or location type such as a hotel property or small coffee shop business and other such features. Rules may also be configured based on account, physical or logical network, virtual network characteristics and/or the type of connection such as, but not limited to, free, paid limited access, or paid full access. These rules may also be automatically or dynamically derived based on real-time factors or conditions such as active URL, page content, time of day, day of week, use, current events or other factors that might affect the triggering or targeting of dynamic content.

A non-limiting example illustrating an example process flow will now be described. A user may access a free public WiFi network hotspot (that is privately owned) with terms and conditions covering network usage and advertising (e.g., where the user clicks on an accept control or otherwise indicates acceptance of the terms and conditions). When the user accesses Internet content, such as a web page, via the private network, the rules defined by the private network operator for the private network may cause the system to selectively enable (or block) specific advertisements to pass through the private network based on specific conditions, such as, by way of example, appropriate rating, publisher URL or node, and/or pre-established agreements such as an access fee or threshold revenue amount. By way of further example, an advertiser may utilize an HTML tag and URL reference to return their advertisement. The ad tag may be in the form of an HTML place holder, and may be inserted by the publisher when a page (e.g., an HTML Web page) is served. Optionally, when the page reaches the user terminal, an ad tag script is executed by the browser, and passes back information to the ad provider system, such as cookie data, IP address and/or the current URL, enabling the ad provider to dynamically select a relevant or best ad for the user. The ad image may not actually be in the page. Instead, a reference to a program that will find the image may be included in the tag. The CEMS, applying the private network operator rules, may parse this tag and/or programmatically reference the tag's characteristics and determine not to show this advertisement if the content rating is determined (e.g., by inspecting a content rating tag, or by calling back for the object to display) to be not appropriate for the viewer and/or the location (e.g., the website the viewer is viewing or the physical facility housing the WiFi hotspot). For example, a coffee shop with a hotspot may not want obscene or offensive material to be displayed on user terminals, within the coffee shop, accessing the hotspot. The rules, as applied by the CEMS, may also evaluate a revenue attribute for this particular advertisement (e.g., by inspecting an appropriate tag) by comparing the revenue attribute to an acceptance threshold value as pre-specified by the network operator or as otherwise specified, and choose not to allow the advertisement to pass through the network if the revenue attribute is determined to be below the acceptance threshold.

If, in this example, the CEMS determines that revenue is above the acceptance threshold (as pre-specified by the network operator or as otherwise specified) and the rules indicate the advertisement is to be allowed to pass, the system may enable the advertisement to be delivered to the user's terminal, the delivery of the advertisement may be recorded by the system, optionally in association with some or all of the associated tag information, such as tag information identifying the publisher, the advertisement, the revenue offered for the ad, the network or networks the advertisement passes through, and/or other such information. Such stored tag information may be utilized by the CEMS or otherwise to determine who revenue is to be collected from. For example, the CEMS may use the tag information to collect revenue from (e.g., charged to) the registered publisher of the ad.

In a scenario in which the advertisement had to pass through multiple private networks (previously registered in the network), such as passing first through an Internet service provider (ISP), and then through an operator's private hotel network, and finally to a WiFi network operated at a concession shop at the hotel, then a portion of the revenue may be shared between each of these operators equally or computed based on the network length, cost, number of routers or other similar characteristics of the networks. Optionally, not all network private operators whose networks the advertisement traverses are entitled to such revenue. Optionally, where a user's terminal (e.g., a computer) may also contribute to this delivery (e.g., by receiving and display the advertisement), and the rules may also be applied with respect to the user and/or user terminal, the user may share in revenues enabling the distribution of content. The registry may also store user-specific data and enable the user to also configure rules governing the permission or denial of content passing into their computer in the same or similar manner as the network operators.

Optionally, the CEMS does not censor based on content subject matter, but rather validates the source, and based on the source validation results, may selectively enable content to be provided for display on a user terminal or may prevent such display from occurring. For example, the CEMS may optionally act as an independent registration system to help validate publishers and help access providers and users monetize their equipment.

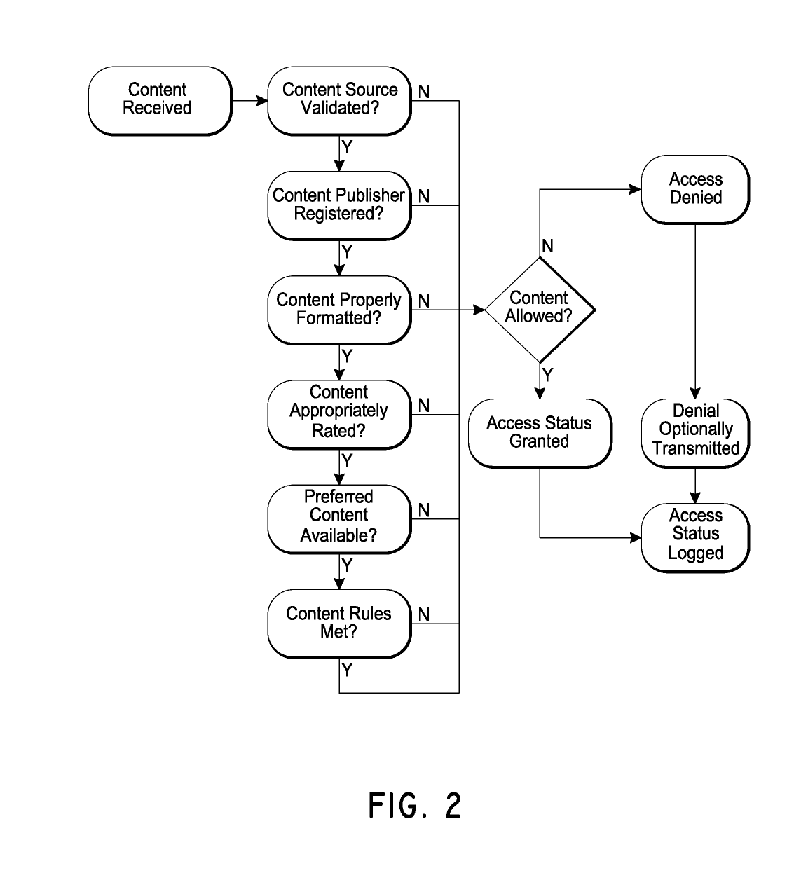

For this example, CEMS may employ the example process shown in FIG. 2 to selectively allow or restrict access of content based at least in part on the access provider's and/or the user's pre-determined settings. Unlike conventional URL or ad blockers applications, the CEMS may instead or in addition evaluate the source and attributes of a given content element to determine whether the defined rules of the access provider and/or user indicate that this content is permitted to be routed over their equipment and/or provided to the user terminal (e.g., laptop, tablet, desktop, cell phone, networked television, etc.), or whether the rules indicate that the content is not to be routed over their equipment and/or provided to the user terminal. In some embodiments, multiple network providers are involved in the transmission. In some embodiments, the network provider closest to the user may have the highest priority for defining rules and/or permitting content to be routed over their equipment.

Additionally, an access provider or user may permit content to be routed and/or displayed for value received. For example, the access provider may allow advertising content to pass over their network for a fee to help offset the cost of the equipment necessary to enable the user's connection. As another example, there may be users who do not particularly like advertisements but who are willing to selectively accept the display of such advertisements on the user's terminal in exchange for free access or content. However, by way of example, the user may want to limit the type or size (e.g., in terms of the number of bytes) of the advertisement when bandwidth is limited or shared. Thus, the system may enable the user to specify ad acceptance criteria, which may include size, type (e.g., text, graphics, photographs, video, and/or audio), source, rating, etc., which will be used by the system to determine whether or not to permit an ad to be displayed to the user. This form of advertisement control may also appeal to access providers who often pay significantly more to enable greater bandwidth. By restricting undesirable content from traversing their systems, access providers can reduce their costs and improve user browsing experience without requiring the installation of expensive equipment that throttles bandwidth at the network layer.

A publisher and network registration system may be implemented as a client program or an Internet application that may permit publishers and/or advertisers to register with a registry their entity, URL (or other locator information), and optionally other specific data such as publisher category (or categories), contact information, revenues share percentage, types of content, rating status, and optionally enables these registrants to create accounts to manage their registration profile.

The publisher and network registration system may optionally utilize a database or other data store to store certain characteristics regarding content publishers including, but not limited to, the publisher name, the business entity, the publisher URL, the IP address or IP addresses assigned to or used by the publisher, the type of published content, the publisher's self-determined rating (e.g., an age appropriateness rating, a violence rating, a sexual content rating, an obscene language rating, etc.), a public or industry accepting rating (e.g., an age appropriateness rating, a violence rating, a sexual content rating, an obscene language rating, etc.), fees associated with certain content, and/or other such information to enable the registry to accurately define and validate publishers.

In some embodiments, the publisher and network registration system may be implemented as a database in a central computer (which may comprise multiple geographically distributed systems) that is referenced by the network nodes in determining whether to pass published content to a viewer. This technique enables certain information to be omitted from the individual ad tags. For example, the fee structure for a particular publisher may be standardized, and a given an ad served that is provided by that publisher may be assigned that particular fee structure. Accordingly, the fee structure need not be included in the individual ad tags, but rather may be retrieved from the central computer containing the publisher and network registration system.

In other embodiments, the publisher and network registration system may be implemented as a syndicated database or list, in which the database or list is copied to distributed locations on the network (e.g., the Internet). For example, the distributed locations may include a series of distributed servers or proxies. As noted above, this may permit certain information to be omitted from individual ad tags, such as Type, Fee, etc.

Accordingly, the database of registered ads may be accessed in a number of ways, including by way of example, via an HTML page, as a syndicated reference list, and/or as a central reference list. In any of these approaches, whether a given advertiser has agreed to pay a fee can be determined by querying the database. If the database response to the query with an indication advertiser has not agreed to pay such a fee, the content may be blocked, and different content may be served instead.

In order to prevent or inhibit fraud, spoofing or other method to circumvent validation, the publisher and network registration system may optionally utilizes other certificate authorities or listing services, such as the Internet Directory Naming Service (DNS) by way of example, to further validate a publisher. For example, the Internet DNS is a service that resolves and translates URLs, such as Yahoo.com, Google.com, and NYTimes.com, into the physical Internet IP Addresses that represents a URL or URI or other such reference, enabling computers and routers to connect with their respective Internet services. For example, an Internet PING for Yahoo.com may return 209.191.122.70 from DNS Service hosted by AT&T. A PING for Google.com and NYTimes.com returns 74.125.224.180 and 199.239.136.200 respectively. This information may be used by the system to compare and match published content source address with registered addresses to validate publisher integrity.

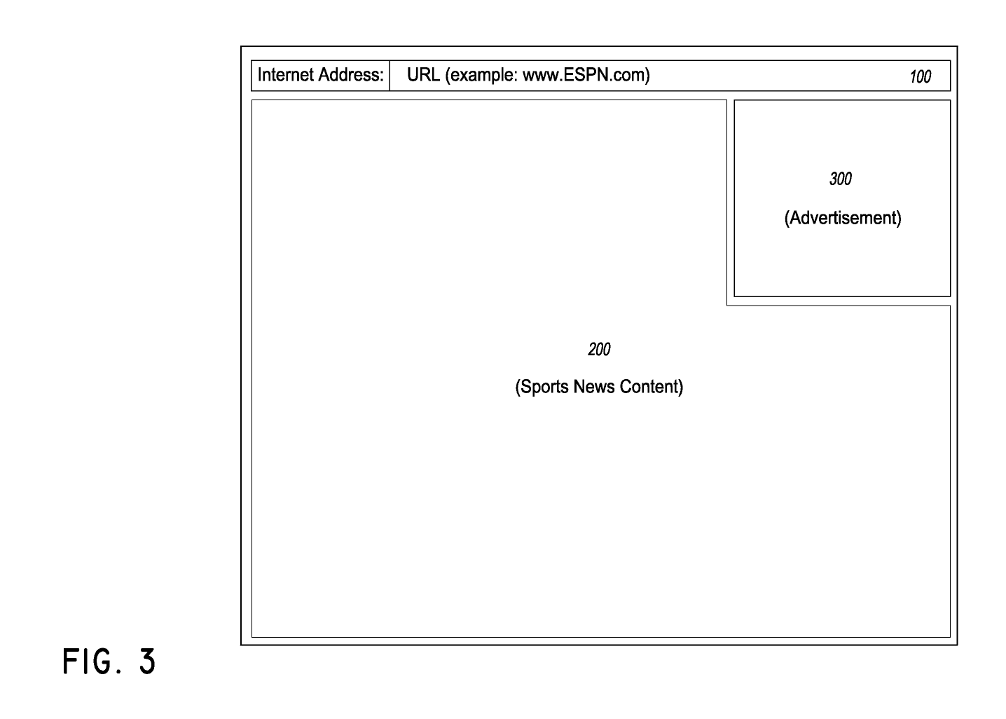

For example, FIG. 3 illustrates further the utilization of the DNS to help verify a publisher's Internet credentials. In some embodiments, DNS may be expanded to help serve the role of register as a partner. In the illustrated example, a popular sports destination site 100 is providing recent sports news 200, and embedded next to or in-line with the article is an advisement from a large ad network or well-known advertiser 300.

In this example, the sport news site 100 has previously registered with the publisher and network registration system as a publisher, and listed its known IP addresses from which the site 100 publishes. The news article 200 being published is encapsulated with HTML content tags that reference respective registry identifier(s) and other attributes regarding the article 200 content. Similarly, the advertiser 300, providing the advertisement and/or ad tag, also encapsulates their content with HTML tags referencing respective registry identifier(s) and other attributes describing the content being provided by the advertiser (an advertisement).

By way of example, the advertiser may register their entity and IP addresses, which may be used by the system to authenticate the advertiser when placing the advertiser's ads. The advertiser may also specify, via a form hosted by the system or otherwise, a revenue sharing specification (e.g., a general revenue share of 25%) which would be applied to the advertiser's paid ads. Optionally, an ad tag itself might include attributes (e.g., value pairs) identifying the publisher, advertisement, advertisement dimensions, advertisement type (e.g., CPM, CPC, etc.), ad revenue (e.g., ad revenue per impression), ad rating (e.g., G, Youth, PG, PG13, R, Mature, etc.), ad event (e.g., pay per click), ad encoding format (e.g., UTF), etc. The following are example attributes that may be associated with a particular example ad:

Publisher ID=234,

Ad ID=Number to track a particular impression for audit,

Ad Size/Shape

Ad Height=300

Ad Width=250

Ad Type=CPM

Ad Revenue=0.0001/Ad or 0.1/1000 impressions

Ad Rating=G

Ad Event=Pay-Per-Click

Ad Local=UTF

As noted previously, in some embodiments one or more of these attributes may be omitted from the ad tag itself. The system may store, maintain and provide/output an audit record report indicating the ad detail and the network(s) the ad traversed, and optionally including an identification that the ad was delivered and/or displayed on the user's terminal.

Therefore, in certain embodiments, the ad network may also register with system and may include an ad network identifier in the ad network's data associated with the ad.

Optionally, the foregoing tags and/or other related tags may form the basis of a formal or informal standard, so that publishers may expose their revenue paid via a tag attribute (which may be relatively fast but viewable by end users and competitors) and/or a via reference look-up table where the look up is performed using an identifier, such as an Ad ID, that enables the system to identify the corresponding access rule(s) to be used to query the revenue amount and let the ad pass so that it may be delivered to a viewer terminal or prevent the ad from reaching the viewer terminal and/or from being displayed via the viewer terminal. If the ad is prevented from reaching the viewer terminal, another ad may be selected and substituted by the system (e.g., based on user demographics and/or user interests, or without taking into account user specific information) to take the place of the banned advertisement, and the replacement ad may be displayed with the surrounding content (if any) on the user's terminal.

For the purpose of this example the following scenarios may occur in determining whether to permit an advertisement from an advertiser to be permitted to pass through one or more network provider systems and be displayed on a user terminal:

the advertiser has not previously registered with the registry;

the advertiser has previously registered with the registry and provided all the information to be validated in order to permit the advertiser's ads to be permitted to pass to the user terminal;

the advertiser has previously registered and has not provided all the information to be validated;

the advertiser has previously registered with the registry, however the advertiser's account is inactive due to nonpayment or failure to enter into payment contract;

the advertiser has previously registered and has provided all the information to be validated but was not allowed to pass because of specific conditions or based at least in part on rules set by the network owner;

the tag represents a previously registered advertiser but failed authentication or appears fraudulent and was not permitted.

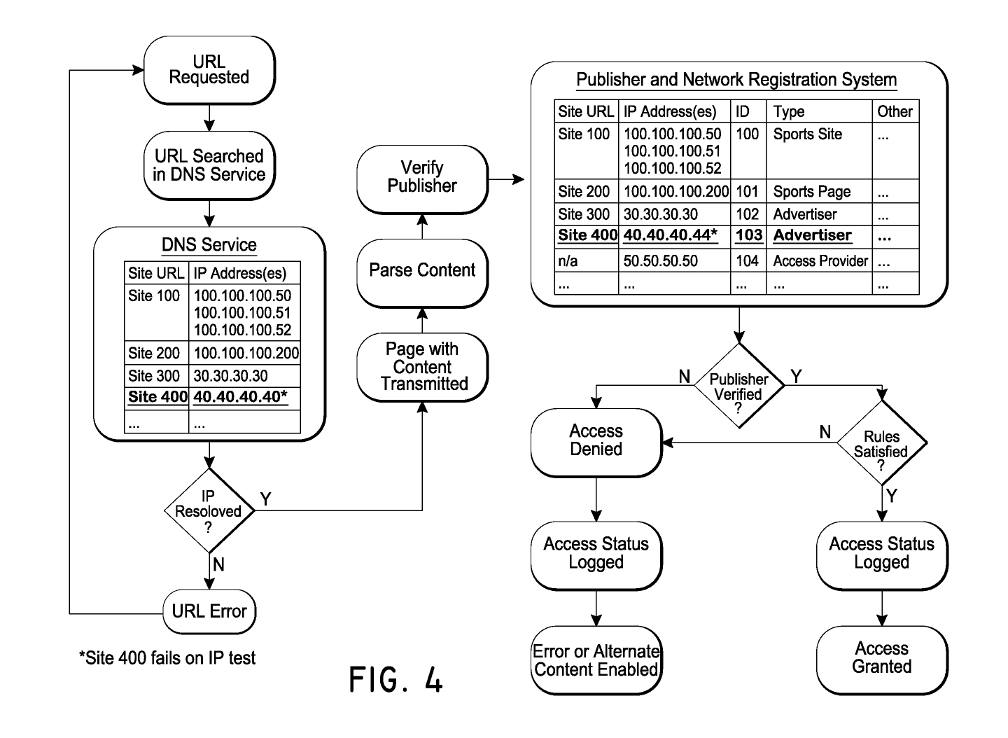

To simplify this example for illustrative purposes it will be assumed that the sport site 100 may have previously registered with the publisher and network registration system and satisfies all authentication criteria needed to permit their content to pass, and only consider the Advertiser for this authentication example. FIG. 4 helps illustrate this example.

Given that HTTP and similar Internet protocols use URL references to link content to a source publisher, then in this case the Advertiser's 300 content would have been served either directly from the Site Publisher 100 or as a reference using ad tags or a URL that link to the Advertiser's 300 content or advertisement. Since the source of the content is inherently resolved by the DNS, its origination can be validated using the publisher and network registration system before the content is permitted to pass over the access provider's network.

If the advertiser 300 has previously registered and entered its correct IP address then the values returned by the DNS will match those entered for this specific advertiser 300 thereby enabling the CEMS to validate the authenticity and integrity of the publisher. If the advertiser 300 has not previously registered or the data stored in the advertiser's 300 profile does not match DNS values, the CEMS may prevent or inhibit the content from passing over the network at issue. For example, the CEMS may strip the advertiser's 300 content by removing links, files, or documents from the site 100. In some embodiments, the content may be blocked based on the name of the reference, the URL, logical name with or without DNS requirement, MIME Type (e.g., jpg, mp4, etc.), protocol, or other approaches. If no alternative content is provided for the blocked content, an error message, such as an HTTP error (e.g., 404 error (page not found)) may be provided in place of the blocked content. In some embodiments, if the content is prevented from reaching the viewer terminal, other content may be selected and substituted by the system to take the place of the blocked content, and the replacement content may be displayed with the surrounding content (if any) on the user's terminal. The substitution content may optionally be selected based at least in part on relevancy to the user, relevancy to the surrounding content, size, media type, a fee paid by a publisher of the substitute content, and/or otherwise. In some embodiments, the HTTP error such as a 404 error (page not found) is provided, which may then be overlaid or replaced with replacement content.

If the advertiser 300 has registered with the registry, but the advertisement data failed to be validate, a message or error status may be transmitted by the system to the registered advertiser by email, instant message, short message, application, or other technique, and the message or error status may also be logged in the registry database, which may be provided via an advertiser account user interface for that advertiser to review. However, optionally, it is not sufficient for the advertiser 300 to be validated in order to be permitted to pass through the access providers network. Optionally, there may be several rules or prerequisites each content provider or advertiser must meet before the content is permitted to traverse their networks.

Advertisers themselves may be sensitive with respect to where their advertisements are displayed (e.g., on which pages or websites). For example, certain brand companies may avoid displaying advertisements on unwholesome websites. Conversely, certain companies targeting products to a mature audience may wish to display advertisements particularly on unwholesome websites. Additionally, websites may be sensitive to the type of advertisements that are displayed on their sites. Certain embodiments enable advertisers to specify rules which will govern how and where the CEMS will permit their advertisements to be displayed.

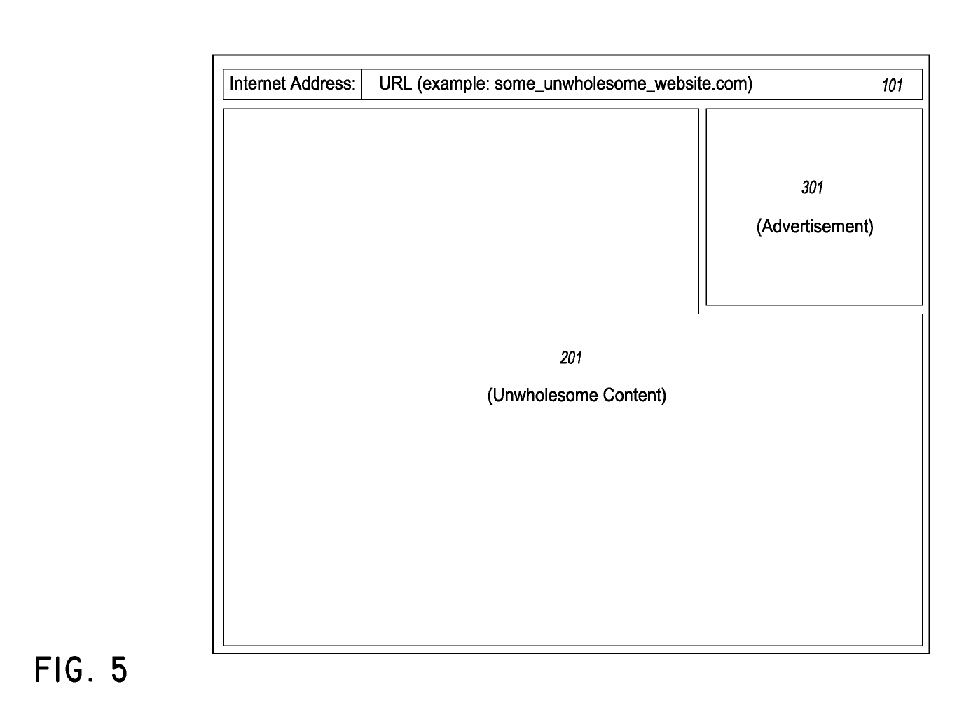

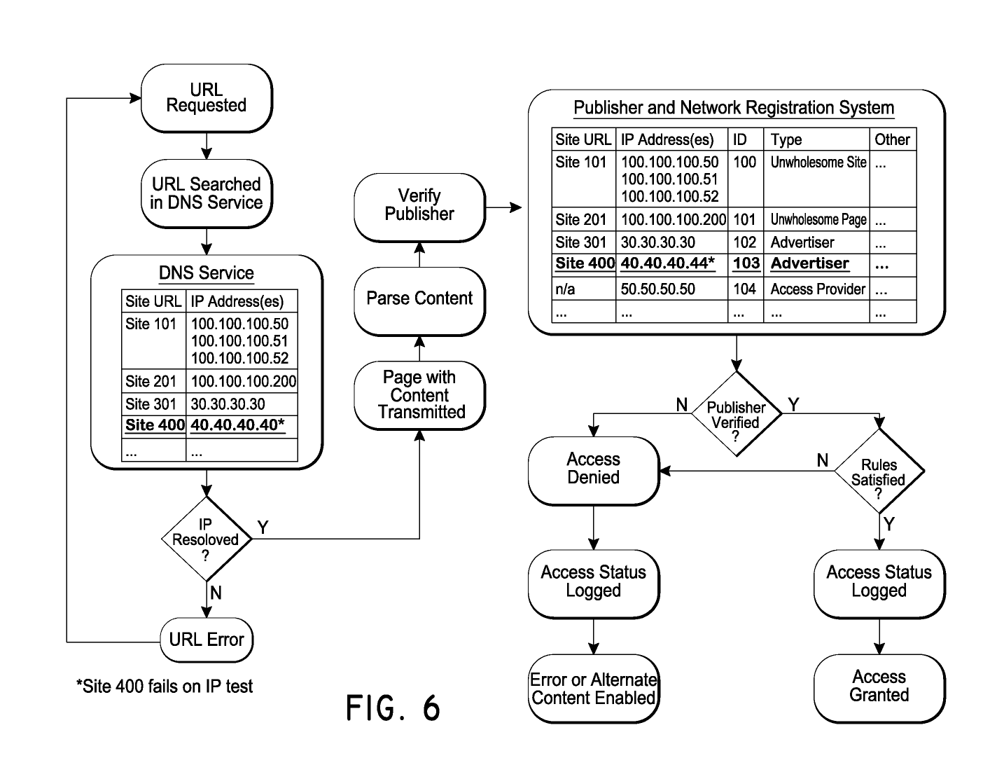

For example, FIGS. 5 and 6 illustrate another example process utilizing the DNS to help verify a publisher's Internet credentials and in applying system rules. In this example, an unwholesome website 101 is providing unwholesome content 201, and embedded next to or in-line with the article is an advisement from a large ad network or well-known advertiser 301. By way of example, the unwholesome content may be related to pornography, gambling, violence, or various other types of content that might offend certain users.

In this example, the unwholesome website 101 may have previously registered with the publisher and network registration system as a publisher, and listed its known IP addresses from which the site 101 publishes. The unwholesome content 201 being published may be encapsulated with HTML Content tags that reference their registry identifier(s) and other attributes about this content. Similarly, the advertiser 301, providing the advertisement or ad tag, may also encapsulate their content with HTML tags referencing their registry identifier(s) and other attributes describing their content.

By way of example, the advertiser may register their entity and IP addresses, which may be used by the system to authenticate the advertiser when placing the advertiser's ads. The advertiser or other entity may also specify, via a form hosted by the system or otherwise, whether the particular advertisement 301 is one that should only be displayed on wholesome websites, i.e. whether the advertisement 301 is wholesome-targeted. Likewise, the advertiser or other entity may specify, via a form hosted by the system or otherwise, whether the particular advertisement 301 is one that should only be displayed on unwholesome websites, i.e., whether the advertisement 301 is unwholesome-targeted. For example, as noted above, certain brands may only wish to display advertisements on wholesome websites so as not to tarnish the brand. This categorization of the advertisement 301 may be offered by the advertiser, or may be determined by another entity. Optionally, an ad tag (or tags) itself might include these attributes. As noted previously, in some embodiments one or more of these attributes may be omitted from the ad tag itself. In some embodiments, categorization can be site/venue driven. For example, unwholesome content may be permitted within a hotel (as it is private), but not in a public café. Accordingly, in some embodiments the same advertisement from the same publisher may be treated differently according to the venue. As described elsewhere herein, if unwholesome content is blocked, a different advertisement may be placed to be displayed in its place. In various embodiments, the replacement advertisement may be selected from the same publisher or from a different publisher.

Optionally, the foregoing tags and/or other related attributes may enable the system to identify the corresponding access rule(s) to be used by the system to determine whether to let the ad pass so that it may be delivered to a viewer terminal or to prevent the ad from reaching the viewer terminal and/or from being displayed via the viewer terminal. For example, if the advertisement 301 is determined by the system (e.g., based on a respective ad tag) to be wholesome-targeted, the system may prevent the ad from reaching the viewer terminal in the scenario that the content 201 is unwholesome. If the ad is prevented from reaching the viewer terminal, another ad may be substituted by the system to take the place of the banned advertisement, and the replacement ad may be displayed with the surrounding content (if any) on the user's terminal. In some embodiments, an unwholesome-targeted ad may be selected for replacement of the blocked advertisement.

For the purpose of this example the following scenarios may occur in determining whether to permit an advertisement from an advertiser to be permitted to pass through one or more network provider systems and be displayed on a user terminal:

the advertiser has not previously registered with the registry;

the advertiser has previously registered with the registry, however the advertiser's account is inactive due to nonpayment or failure to enter into payment contract;

the advertiser has previously registered with the registry and has provided all the information to be validated and permitted to pass;

the advertiser has previously registered with the registry and has not provided all the information to be validated;

the advertiser has previously registered and has provided all the information to be validated but was not allowed to pass because of specific conditions or based at least in part on rules set by the network owner;

the tag represents a previously registered advertiser but failed authentication or appears fraudulent and was not permitted;

the advertiser has previously registered and provided all the information to be validated but was not allowed to be displayed on the unwholesome site because the advertisement is identified as wholesome-targeted.

To simplify this example for illustrative purposes, it is assumed that the unwholesome site 101 has previously registered with the publisher and network registration system and satisfies the needed authentications to permit their content to pass, and so only the advertiser-specified criteria is discussed for this authentication example. Further, the unwholesome site 101 has been identified by the publisher and network registration system (whether by the site 101 itself or by another entity) that it is unwholesome. In some embodiments, the publisher and network registration system may maintain a list of identified unwholesome sites. In some embodiments, the site 101 may be analyzed by the publisher or network registration system to determine whether or not it may be categorized as unwholesome.

Given that HTTP and similar Internet protocols use URL references to link content to a source publisher, then in this case the advertiser's 301 content would have been served either directly from the site publisher 101 or as a reference using ad tags or a URL that link to the advertiser's content or advertisement. Since the source of the content is resolved by the DNS, its origination can be validated using the publisher and network registration system before the content is permitted to pass over the access provider's network.

If the advertiser 301 has previously registered and entered its correct IP address, then the system will determine that the values returned by the DNS match those entered for this specific advertiser 301, thereby validating the authenticity and integrity of the publisher. If the advertiser 301 has not previously registered or the data stored in the advertiser's 301 profile does not match DNS values, the system will prevent the content from passing over the network. For example, the CEMS may strip the advertiser's 301 content by removing links, files, or documents from the site 101.

If the advertiser 301 has registered but the system determines that the advertisement has been identified as wholesome-targeted, the system may prevent the advertisement from being displayed on a webpage of the unwholesome site. If no alternative content is provided for the blocked content, an error message, such as an HTTP error (e.g., 404 error (page not found)) may be provided in place of the blocked content. In some embodiments, if the content is prevented from reaching the viewer terminal, other content may be selected and substituted by the system to take the place of the blocked content, and the replacement content may be displayed with the surrounding content (if any) on the user's terminal. The substitution content may optionally be selected based at least in part on relevancy to the user, relevancy to the surrounding content, size, media type, a fee paid by a publisher of the substitute content, and/or otherwise. In some embodiments, the HTTP error such as a 404 error (page not found) is provided, which may then be overlaid or replaced with replacement content. In some embodiments, a replacement ad may be inserted in place of the blocked advertisement. For example, an unwholesome-targeted advertisement may be inserted in place of the blocked advertisement. Optionally, there may be several rules or prerequisites each content provider or advertiser must meet, as determined by the system, before the content is permitted.

As noted above, certain companies targeting products to a mature audience may wish to display advertisements particularly on unwholesome websites. Additionally, it may be undesirable to display unwholesome-targeted advertisements on wholesome websites.

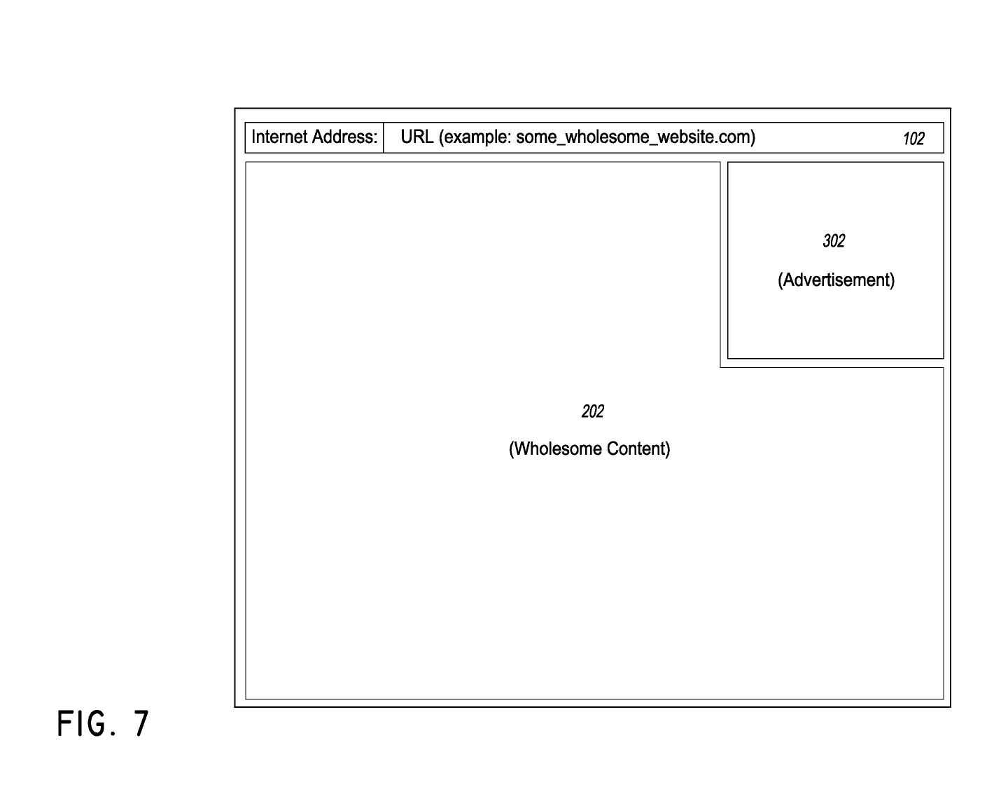

For example, FIGS. 6 and 7 illustrate another example process utilizing the DNS to help verify a publisher's Internet credentials and in applying system rules, in which a wholesome website 102 provides wholesome content 202. Embedded next to or in-line with the wholesome content 202 is an advertisement 302. In various embodiments, the wholesome content may be directed to general audiences, with little or no content that may offend certain users.

The advertiser or other entity may also specify, via a form hosted by the system or otherwise, whether the particular content from advertiser 302 is one that should only be displayed on wholesome websites, i.e. whether the content from advertiser 302 is wholesome-targeted. Likewise, the advertiser or other entity may specify, via a form hosted by the system or otherwise, whether the particular advertisement 302 is one that should only be displayed on unwholesome websites, i.e., whether the content from advertiser 302 is unwholesome-targeted. For example, as noted above, certain brands may only wish to display advertisements on unwholesome websites so as reach a desired user audience. This categorization of the content from advertiser 302 may be offered by the advertiser, or may be determined by another entity. Optionally, an ad tag itself might include these attributes. As noted previously, in some embodiments one or more of these attributes may be omitted from the ad tag itself.

Optionally, the foregoing tags and/or other related attributes may enable the system to identify the corresponding access rule(s) to be used to determine whether to let the ad pass so that it may be delivered to a viewer terminal or prevent the ad from reaching the viewer terminal and/or from being displayed via the viewer terminal. For example, if the content from advertiser 302 is determined to be unwholesome-targeted, the system may prevent the ad from reaching the viewer terminal in the scenario that the content 202 is wholesome. If the ad is prevented from reaching the viewer terminal, another ad may be substituted by the system to take the place of the banned advertisement, and the replacement ad may be displayed with the surrounding content (if any) on the user's terminal. In some embodiments, a wholesome-targeted ad may be selected for replacement of the blocked advertisement.

For the purpose of this example the following scenarios may occur in determining whether to permit an advertisement from an advertiser to be permitted to pass through one or more network provider systems and be displayed on a user terminal:

the advertiser has not previously registered with the registry;

the advertiser has previously registered with the registry and has provided all the information to be validated and permitted to pass;

the advertiser has previously registered with the registry, however the advertiser's account is inactive due to nonpayment or failure to enter into payment contract;

the advertiser has previously registered with the registry and has not provided all the information to be validated;

the advertiser has previously registered and has provided all the information to be validated but was not allowed to pass because of specific conditions or based at least in part on rules set by the network owner;

the tag represents a previously registered advertiser but failed authentication or appears fraudulent and was not permitted;

the advertiser has previously registered and provided all the information to be validated but was not allowed to be displayed on the wholesome site because the advertisement is identified as unwholesome-targeted.

To simplify this example for illustrative purposes it is assumed that the wholesome site 102 has previously registered with the publisher and network registration system and satisfies the needed authentications to permit their content to pass, and so only the advertiser specified criteria is discussed for this authentication example. Further, the wholesome site 102 has been identified by the publisher and network registration system (whether by the site 102 itself or another entity) that it is wholesome. In some embodiments, the publisher and network registration system may maintain a list of identified wholesome sites. In some embodiments, the site 102 may be analyzed by the publisher and network registration system to determine whether or not it may be categorized as wholesome.

Given that HTTP and similar Internet protocols use URL references to link content to a source publisher, then in this example the advertiser's content would have been served either directly from the site 102 or as a reference using ad tags or a URL that link to the advertiser's content or advertisement. Since the source of the content is resolved by the DNS, its origination can be validated using the publisher and network registration system before the content is permitted to pass over the access provider's network.

If the advertiser 302 has previously registered and entered its correct IP Address then the values returned by the DNS will match those entered for this specific advertiser 302 thereby validating the authenticity and integrity of the publisher. If the advertiser 302 has not previously registered or the data stored in the advertiser's profile does not match DNS values, the system will prevent the content from passing over the network. For example, the CEMS may strip the advertiser's 301 content by removing links, files, or documents from the site 101.

If the advertiser 302 has registered but the system determines that the advertisement has been identified as unwholesome-targeted, the system may prevent the advertisement from being displayed on a webpage of the wholesome site. If no alternative content is provided for the blocked content, an error message, such as an HTTP error (e.g., 404 error (page not found)) may be provided in place of the blocked content. In some embodiments, if the content is prevented from reaching the viewer terminal, other content may be selected and substituted by the system to take the place of the blocked content, and the replacement content may be displayed with the surrounding content (if any) on the user's terminal. In some embodiments, the HTTP error such as a 404 error (page not found) is provided, which may then be overlaid or replaced with replacement content. In some embodiments, a replacement ad may be inserted in place of the blocked advertisement. For example, a wholesome-targeted advertisement may be inserted in place of the blocked advertisement. Optionally, there may be several rules or prerequisites each content provider or advertiser must meet, as determined by the system, before the content is permitted.

In some embodiments, a website may be identified by the publisher and network registration system as fragile (e.g., likely to become dysfunctional upon blocking or replacing content). For such identified fragile sites, the system may refrain from blocking or replacing any advertisements. For example, some sites may be known to become dysfunctional upon blocking or replacing advertisements. These sites may be communicated to the system as fragile, or the system may independently determine whether such sites are fragile.

The publisher and network registration system may also help Internet access providers protect their customers from potential viruses because it optionally authenticates the source for a given script delivered to a computer. It also may help Internet access providers better manage their bandwidth by optionally implementing content publisher rules that actively select, or default to lower bandwidth content options, block content, or substitute preferred content over higher cost content.

The publisher and network registration system may also provide reporting services that enable publishers to view where and when their content was permitted entry and where (e.g., over which private networks, on which terminals) and when their content was not allowed. When their content was not allowed, the database may record and report reasons why the content as not allowed, such as poor ratings, inappropriate content, insufficient entry fee, lost to competitive bid, or other reasons rules or requirements implemented by the Internet access provider.

In many cases there may be several Internet access providers connected together to form a complete path from the publisher to the end user. This series of network connections may represent a content distribution network in which each of the connect segments may be registered in the content authentication registry.

The content authenticate registry service may also enable Internet Access Providers to register their networks and network nodes in this registry to enable the tracking and reporting of when and where content was permitted or denied access to pass through a particular network or portion thereof. This data may include information describing the network and the admission rules.

Another optional feature of this system is its ability to help avoid DNS Poisoning or DNS Redirects. This occurs when a DNS service is compromised or a non-regulated, un-trusted DNS service is placed between the requesting URL and a valid DNS service. An example embodiment of the publisher and network registration system helps ensures the content is being published from a validated source by comparing the resolved IP Address with the registered IP Address. When an invalid DNS is present, the system can intercept DNS requests, but the IP Address for the URL returned will not match the IP Address registered in the publisher and network registration service, causing an error or alert condition to be generated by the system.

In some embodiments described herein, the publisher and network registration system operates as an “allow” list, in which content is blocked from being presented to a user unless the publisher has been registered and the content meets any other criteria present. However, in other embodiments, the publisher and network registration system may be configured to operate as a “block” list, in which content is allowed to pass through to be viewed by a user unless the content has been identified by the system as impermissible. For example, the system may be configured to block all advertisements provided by a particular publisher, such as Double-Click or Value-Click.

Certain embodiments may be implemented via hardware, software stored on media, or a combination of hardware and software. For example, certain embodiments may include software/program instructions/modules stored on tangible, non-transitory computer-readable medium (e.g., magnetic memory/discs, optical memory/discs, RAM, ROM, FLASH memory, other semiconductor memory, etc.), accessible by one or more computing devices configured to execute the software (e.g., servers or other computing device including one or more processors, wired and/or wireless network interfaces (e.g., cellular, Wi-Fi, Bluetooth, T1, DSL, cable, optical, or other interface(s) which may be coupled to the Internet), content databases, customer account databases, etc.). Data stores (e.g., databases) may be used to store some or all of the information discussed herein in memory.

By way of example, a given computing device may optionally include user interface devices, such as some or all of the following: one or more displays, keyboards, touch screens, speakers, microphones, mice, track balls, touch pads, tilt sensors, accelerometers, biometric sensors (e.g., fingerprint or face recognition sensors for authenticating a user) printers, etc. The computing device may optionally include a media read/write device, such as a CD, DVD, Blu-ray, tape, magnetic disc, semiconductor memory, or other optical, magnetic, and/or solid state media device. A computing device, such as a user terminal, may be in the form of a general purpose computer, a personal computer, a laptop, a tablet computer, a mobile or stationary telephone, an interactive television, a set top box coupled to a display, etc. Certain embodiments may be able to conduct hundreds (or more) of transactions and processes described herein within a second.

While certain embodiments may be illustrated or discussed as having certain example components, additional, fewer, or different components may be used. Process described as being performed by a given system may be performed by a user terminal or other system or systems. Processes described as being performed by a user terminal may be performed by another system. Data described as being accessed from a given source may be stored by and accessed from other sources. Transmissions described herein may be via a wired and/or wireless network or other communications link. Further, with respect to the processes discussed herein, various states may be performed in a different order, not all states are required to be reached, and fewer, additional, or different states may be utilized.

User interfaces described herein are optionally presented (and user instructions may be received) via a user computing device using a browser, other network resource viewer, or otherwise. For example, the user interfaces may be presented (and user optionally instructions received) via an application (sometimes referred to as an “app”) installed on the user's mobile phone, laptop, pad, desktop, television, set top box, phone, or other terminal. Various features described or illustrated as being present in different embodiments or user interfaces may be combined into the same embodiment or user interface. While reference may be made to webpages, other types of electronic documents (including those not based on HTML) may be used. While reference may be made to websites, other network resources may be used.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein. Further, embodiments may include several novel features, no single one of which is solely responsible for the embodiment's desirable attributes or which is essential to practicing the systems, devices, methods, and techniques described herein. In addition, various features of different embodiments may be combined to form still further embodiments. For example, aspects found in different user interfaces may be combined to form still further user interface.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A method of controlling transmission of digital content to a user terminal, the method comprising:
receiving, at a network node, data for a webpage from a remote system or systems, wherein the webpage is to be displayed on the user terminal;
causing, at least in part, an automatic identification of a first advertisement in the webpage data;
identifying, from data associated with the first advertisement, a publisher of the first advertisement;
automatically determining whether the publisher of the first advertisement is included in a registration database, wherein the registration database comprises an identification of publishers that have agreed to pay fees in exchange for passage of advertisements over at least a first network;
at least partly in response to determining that the publisher of the first advertisement is included in a registration database, generating an indication that the first advertisement is to be displayed on the user terminal;
at least partly in response to determining that the publisher of the first advertisement is not included in a registration database, generating an indication that the first advertisement is not to be displayed on the user terminal;
outputting the webpage to a web browser associated with the user terminal, wherein:
the first advertisement is displayed on the webpage at least partly in response to the indication that the first advertisement is to be displayed on the user terminal; and
the first advertisement is replaced or obscured at least partly in response to the indication that the first advertisement is not to be displayed on the user terminal.

2. A method of controlling transmission of digital content to a user terminal, the method comprising:
receiving, at a network node, data for a first document from a remote system or systems, wherein the first document is to be displayed on the user terminal of a user;
causing, at least in part, an automatic identification of a first advertisement in the first document data;
determining whether the first advertisement is permissible based at least in part on one or more characteristics comprising:
(a) identity of a publisher of the first advertisement;
(b) content rating of the first advertisement; or
(c) revenue offered for the first advertisement;
causing the first document to be output to a user terminal, wherein:
the first advertisement is displayed in the first document if the advertisement is determined to be permissible; or
the first advertisement is replaced or obscured if the first advertisement is determined to be not permissible.

3. The method of claim 2, wherein the first advertisement is replaced or obscured by a second advertisement if first advertisement is not permissible.

4. The method of claim 3, wherein the second advertisement is selected based at least in part on an indication of a size of the first advertisement.

5. The method of claim 3, wherein the second advertisement is permissible based on the one or more characteristics.

6. The method of claim 2, wherein the first advertisement is permissible if the publisher of the first advertisement is included in a registration database, wherein the registration database comprises a list of publishers that have agreed to pay fees in exchange for passage of advertisements.

7. The method of claim 2, wherein the first advertisement is not permissible if the publisher of the first advertisement is included in a block-list database.

8. The method of claim 2, wherein the first advertisement is permissible if the offered revenue is above a specified threshold.

9. The method of claim 8, wherein the threshold is at least one of:
a fee per number of displays;
a fee per click; or
a portion of advertising revenue.

10. The method of claim 2, further comprising storing a record of whether the first advertisement is displayed.

11. The method of claim 10, further comprising causing, at least in part, said record to be provided to a network operator or an Internet access provider.

12. The method of claim 2, wherein determining whether the first advertisement is permissible based on one or more characteristics comprising applying permission rules.

13. The method of claim 12, wherein the permission rules are configured by a network operator or an Internet access provider.

14. The method of claim 12, wherein the permission rules are configured at least in part by the user.

15. The method of claim 2, further comprising communicating a message to the publisher of the first advertisement if the first advertisement is replaced or obscured.

16. A system comprising:
a processor;
tangible, non-transitory media configured to store a program that when executed by the process is configured to perform operations, comprising:
receiving, at a network node, data for a first document from a remote system or systems, wherein the first document is to be displayed on the user terminal of a user;
causing, at least in part, an automatic identification of a first advertisement in the first document data;
determining whether the first advertisement is permissible based at least in part on one or more characteristics comprising:
(a) identity of a publisher of the first advertisement;
(b) content rating of the first advertisement; or
(c) revenue offered for the first advertisement;
causing the first document to be output to a user terminal, wherein:
the first advertisement is displayed in the first document if the advertisement is determined to be permissible; or
the first advertisement is replaced or obscured if the first advertisement is determined to be not permissible.

17. The system of claim 16, wherein the first advertisement is replaced or obscured by a second advertisement if first advertisement is not permissible.

18. The system of claim 17, wherein the second advertisement is selected based at least in part on an indication of a size of the first advertisement.

19. The system of claim 17, wherein the second advertisement is permissible based on the one or more characteristics.

20. The system of claim 16, wherein the first advertisement is permissible if the publisher of the first advertisement is included in a registration database, wherein the registration database comprises a list of publishers that have agreed to pay fees in exchange for passage of advertisements.

21. The system of claim 16, wherein the first advertisement is not permissible if the publisher of the first advertisement is included in a block-list database.

22. The system of claim 16, wherein the first advertisement is permissible if the offered revenue is above a specified threshold.

23. The system of claim 22, wherein the threshold is at least one of:
a fee per number of displays;
a fee per click; or
a portion of advertising revenue.

24. The system of claim 16, the operations further comprising storing a record of whether the first advertisement is displayed.

25. The system of claim 24, the operations further comprising causing, at least in part, said record to be provided to a network operator or an Internet access provider.

26. The system of claim 16, wherein determining whether the first advertisement is permissible based on one or more characteristics comprising applying permission rules.

27. The system of claim 26, wherein the permission rules are configured by a network operator or an Internet access provider.

28. The system of claim 26, wherein the permission rules are configured at least in part by the user.

29. The system of claim 16, the operations further comprising communicating a message to the publisher of the first advertisement if the first advertisement is replaced or obscured.
